(19) United States
(12) Patent Application Publication
(10) Pub. No.: US 2005/0280889 A1
(43) Pub. Date: Dec. 22, 2005

(54) Optimum ultraviolet dose determining tool for ultraviolet radiotherapy

(75) Inventor: Nobuo Katsuzaki, Tokyo-To (JP)

Correspondence Address: SMITH, GAMBRELL & RUSSELL, LLP, 1850 M STREET, N.W., SUITE 800, WASHINGTON, DC, 20036, US

(73) Assignee: Yayoi Co., Ltd.

(21) Appl. No.: 11/098,477

(22) Filed: Apr. 5, 2005

(30) Foreign Application Priority Data
Jun. 17, 2004 (JP) 2004-179786

(51) Int. Cl. G02B 1/00; G02B 5/08; G02B 5/20; F21V 9/04; F21V 9/06; G01J 1/42

(52) U.S. Cl. 359/359; 359/361; 359/350

(57) ABSTRACT

A subject of the present invention is to achieve accurate measurement of an ultraviolet dose of a test region of a subject (patient) by a single measuring cycle, to provide a measuring tool not including any members requiring manual operations, to prevent an examiner from exposure to ultraviolet radiation and to improve safety. An optimum ultraviolet dose determining tool, for ultraviolet radiotherapy, is used to determine an optimum ultraviolet dose in advance. The optimum ultraviolet dose determining tool can be placed on the skin of a patient and is provided with an attenuation filter (1A, 1B or 1C) having a plurality of optical areas respectively having different, known ultraviolet-ray transmittances or reflectances.

### BACKGROUND OF THE INVENTION

1. Field of the Invention

The present invention relates to an optimum ultraviolet dose determining tool for ultraviolet radiotherapy to be used for determining a proper ultraviolet dose prior to ultraviolet radiotherapy.

2. Description of the Related Art

Ultraviolet radiotherapy is an effective medical treatment of dermatoses, such as atopic dermatitis, psoriasis and leukoderma.

Doctors selectively use either of UV-B ultraviolet rays having wavelengths in the range of 285 to 320 nm and UV-A ultraviolet rays having wavelengths in the range of 320 to 400 nm for the treatment of dermatoses.

Ultraviolet radiotherapy using ultraviolet radiation of various wavelengths, similarly to medication, must be performed very consciously and carefully because ultraviolet radiation of those wavelengths is hazardous.

Patients have individual differences; some have tough skins resistant to light and others have weak skins sensitive to light. Therefore, it is important to grasp the quality of the patient's skin prior to ultraviolet radiotherapy.

The individual patient is subjected to an examination to determine a UV-A wave dose and a UV-B wave dose to which the patient is resistant. A UV-B wave used to determine a minimum erytherma dose (MED) and a UV-A wave is used to determine a minimum phototoxic dose (MPD). A safe ultraviolet dose is determined on the basis of the measured MED and MPD.

The foregoing examination uses an optimum ultraviolet dose determining tool.

Referring to FIG. 9(A), a currently used optimum ultraviolet dose determining tool has a base plate b provided with two rows of windows of the same size arranged at fixed intervals, namely, a first row of five windows a₁ to a₅ and a second row of five windows a₆ to a₁₀, first and second slide guides c respectively extending along the first row of the five windows a₁ to a₅ and the second row of the five windows a₆ to a₁₀ of the base plate b, and first and second shutter plates d₁ and d₂ guide for sliding by the guides c, respectively. The first shutter plate d₁ is slid periodically in the direction of the arrow by a distance corresponding to the pitch of the windows at a time to close the windows a₁ to a₆ successively. Subsequently, the second shutter plate d₂ is slid similarly to close all the windows.

The windows a₁ to a₁₀ are square openings 10 mm sq. The shutter plates d₁ and d₂ are slid by a pitch corresponding to that of the windows after ultraviolet irradiation for 30 s.

The base plate b is attached to a part of the patient's skin mostly concealed from sunlight, such as the skin of back, the thigh or the inner side of the arm, by a suitable means for the examination. Subsequently, the part of the patient's body is irradiated with ultraviolet rays of the same intensity through the windows a₁ to a₁₀ of the base plate b. The first slide plate d₁ is slid at equal time intervals (normally, time intervals of 30 s) to close the windows a₁ to a₅ successively. After all the windows a₁ to a₅ have been closed, the second shutter plate d₂ is slid similarly. Radiation of ultraviolet rays is stopped after all the windows a₆ to a₁₀ have been closed to complete the examination.

Then, the base plate b s removed from the skin, the colors of positions of the skin corresponding to the windows a₁ to a₁₀ are examined to determine an MED and an MPD

When the conventional optimum ultraviolet dose determining tool is used, the shutter plates d₁ and d₂ are slid manually to close the windows a₁ to a₁₀ successively while exposure is timed by the examiner. Therefore, doses respectively for the windows a₁ to a₁₀ are not necessarily accurate due to inaccurate timing of ultraviolet irradiation and delay in operations. Consequently, measurements are inaccurate and it is difficult to obtain precise test data.

Since the shutter plates d₁ and d₂ are operated under ultraviolet radiation, the examiner is exposed to ultraviolet radiation.

A procedure for ultraviolet radiotherapy irradiates the whole body of a patient standing or sitting on a chair in a treatment chamber in a cabin like a telephone booth. When the patient is examined for an acceptable ultraviolet dose in such a treatment chamber by using the foregoing conventional optimum ultraviolet dose determining tool, the examiner needs to open the door of the cabin and to enter the treatment chamber periodically to operate the shutter plates d₁ and d₂ manually. Thus the measurement of doses has been difficult.

A means to protect the examiner from exposure to ultraviolet radiation, may electrically drive the shutter plates d₁ and d₂ and to operate the shutter plates d₁ and d₂ by remote control. However, such a method of operating the shutter plates d₁ and d₂ needs an expensive, large-scale, complicated mechanism.

Patent Document 1: IP-A 2004-65330

### SUMMARY OF INVENTION

It is an object of the present invention to provide an optimum ultraviolet dose determining tool, for ultraviolet radiotherapy, having simple construction, capable of preventing exposing an examiner to ultraviolet radiation, not requiring the examiner to enter a treatment chamber of a cabin when doses are measured in the treatment chamber, and capable of efficiently achieving measurement in a short time.

An optimum ultraviolet dose determining tool for ultraviolet radiotherapy according to the present invention for determining an optimum ultraviolet dose prior to ultraviolet radiotherapy includes an attenuation filter capable of being placed on the skin of a patient and having optical areas respectively having different, known ultraviolet-ray transmittances or reflectances.

An optimum ultraviolet dose can be efficiently determined in advance through the comparative observation of the respective degrees of cauterization of parts of the skin exposed to ultraviolet radiation through the optical areas respectively having different, known ultraviolet-ray transmittances or reflectances.

In the optimum ultraviolet dose determining tool according to the present invention, parts of the skin respectively corresponding to the optical areas of the base plate are exposed simultaneously to ultraviolet radiation for the same exposure time.

Thus an optimum ultraviolet dose can be determined through only one measuring cycle.

In the optimum ultraviolet dose determining tool according to the present invention, the attenuation filter has gradient ultraviolet-ray transmittance or reflectance continuously decreasing from one end toward the other end thereof.

When the skin is exposed to ultraviolet radiation by uniformly irradiating the attenuation filter with ultraviolet radiation for a fixed time, parts of the skin are cauterized according to the ultraviolet-ray transmittances or reflectances of parts, corresponding to the parts of the skin, of the attenuation filter in different tints, respectively, because the ultraviolet-ray transmittance or reflectance of the attenuation filter varies continuously from one end toward the other end of the base plate. An optimum ultraviolet dose can be determined through the visual examination of the tints of the parts of the skin. Since the ultraviolet-ray transmittance or reflectance of the attenuation filter changes continuously from one end toward the other end of the base plate, delicate tint variation can be perceived.

In the optimum ultraviolet dose determining tool according to the present invention, the attenuation filter has gradient ultraviolet-ray transmittance or reflectance decreasing stepwise from one end toward the other end thereof.

Thus an optimum ultraviolet dose can be determined through the comparative observation of the tints of the parts, corresponding to the parts of the attenuation filter respectively having different ultraviolet transmittances or reflectances, of the skin.

In the optimum ultraviolet dose determining tool according to the present invention, the attenuation filter is provided with a row of a plurality of windows arranged such that the respective ultraviolet-ray transmittances or reflectances of the windows decrease stepwise in order of arrangement of the windows.

When parts of the skin are exposed simultaneously to ultraviolet radiation through the windows of the attenuation filter, respectively, by uniformly irradiating the attenuation filter with ultraviolet radiation, the parts of the skin are cauterized according to the ultraviolet-ray transmittances or reflectances of the windows, respectively, in different tints, respectively. Therefore, the different tints of the parts of the skin can be easily perceived.

In the optimum ultraviolet dose determining tool according to the present invention, the attenuation filter is held in a case in combination with an ultraviolet lamp.

Since both the attenuation filter and the ultraviolet lamp are held compactly in the case, the optimum ultraviolet dose determining tool is compact in construction and easily portable. Doses can be measured simply by placing the optimum ultraviolet dose determining tool for ultraviolet radiotherapy on the back or the like of the patient, and the optimum ultraviolet dose determining tool for ultraviolet radiotherapy can be used in a narrow hospital room.

The attenuation filter may be formed of a filtering material having parts of different optical densities respectively having different ultraviolet-ray transmittances or reflectances. In the optimum ultraviolet dose determining tool according to the present invention, the attenuation filter may be formed by superposing dielectric layers on a base plate of a nonreflective material, such as quartz glass, and dielectric layers may be superposed on the base plate such that different parts of the dielectric layers have different ultraviolet-ray transmittances or reflectances, respectively.

Thus an optimum ultraviolet dose can be determined in advance through only one measuring cycle by comparatively examining the respective degrees of cauterization of the parts of the skin exposed to ultraviolet radiation through the plurality of optical areas respectively having different, known ultraviolet-ray transmittances or reflectances, respectively.

Since any manual operation for moving a shutter plate is not necessary at all, exposure of the skin to ultraviolet radiation at in correct doses different from intended doses due to failure in correctly timing exposure and delayed operations can be avoided. Consequently, the parts of the skin can be exposed to ultraviolet radiation at correct doses, respectively, and an optimum dose can be accurately determined.

Since the optimum ultraviolet dose determining tool does not have any member requiring manual operation at all, the examiner does not never undergo experience hazardous exposure to ultraviolet radiation, the security of the examiner can be insured, the optimum ultraviolet dose determining tool can be built in very simple construction and is easy to handle.

The optimum ultraviolet dose determining tool is capable of being used for measuring both MED and MPD.

### BRIEF DESCRIPTION OF THE DRAWINGS

FIG. 1 is a plan view of an optimum ultraviolet dose determining tool in a first embodiment according to the present invention for ultraviolet radiotherapy;

FIG. 2 is a graph showing the variation of ultraviolet-ray transmittance of the optimum ultraviolet dose determining tool with distance from one end of the optimum ultraviolet dose determining tool shown in FIG. 1;

FIG. 3 is a typical sectional view taken on the line A-A in FIG. 1;

FIG. 4 is a pictorial view of assistance in explaining the operation of an ultraviolet irradiation system;

FIG. 5 is a plan view of an optimum ultraviolet dose determining tool in a second embodiment according to the present invention;

FIG. 6 is an enlarged, fragmentary sectional view of an attenuation filter;

FIG. 7(A) is a plan view of an optimum ultraviolet dose determining tool in a third embodiment according to the present invention;

FIG. 7(B) is a sectional view taken on the line B-B in FIG. 7(A);

FIG. 8(A) is a plan view of an optimum ultraviolet dose determining tool in a modification of the optimum ultraviolet dose determining tool in the third embodiment;

FIG. 8(B) is a sectional view taken on the line C-C in FIG. 8(A);

FIG. 9(A) is a plan view of a conventional optimum ultraviolet dose determining tool;

FIG. 9(B) is a sectional view taken on the line D-D in FIG. 8(A); and

FIG. 10 is a sectional view of an optimum ultraviolet dose determining tool in a fourth embodiment according to the present invention for ultraviolet radiotherapy.

### DESCRIPTION OF THE PREFERRED EMBODIMENTS

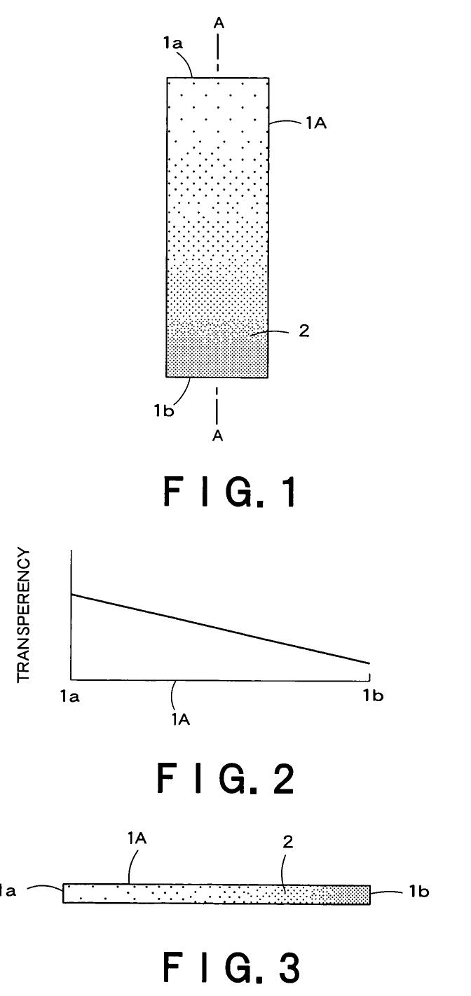

Referring to FIG. 1 showing an optimum ultraviolet dose determining tool in a first embodiment according to the present invention for ultraviolet radiotherapy in a plan view, the optimum ultraviolet dose determining tool has an attenuation filter 1A. The attenuation filter 1A has ultraviolet-ray transmittance decreasing from one end 1a thereof toward the other end 1b thereof. The attenuation filter 1A may be a transmission-type attenuation filter having a plurality of optical areas (transmission areas) respectively having different, known transmittances or may be a reflection-type attenuation filter having a plurality of optical areas (reflecting areas) respectively having different ultraviolet-ray reflectances. When the attenuation filter 1A is of a reflection-type, part of light rays emitted by a light source may be reflected toward a human body.

As shown in a typical sectional view in FIG. 3, the attenuation filter 1A is a plastic sheet formed by forming a material prepared by mixing particles 2 of an ultraviolet-ray intercepting substance in a plastic material in a sheet such that the sheet has gradient density or by applying a material containing particles 2 of an ultraviolet-ray intercepting substance to a sheet such that the plastic sheet has gradient density.

A desired scale may be graduated in one longitudinal side edge of the attenuation filter 1A to facilitate determining doses after irradiation with ultraviolet radiation.

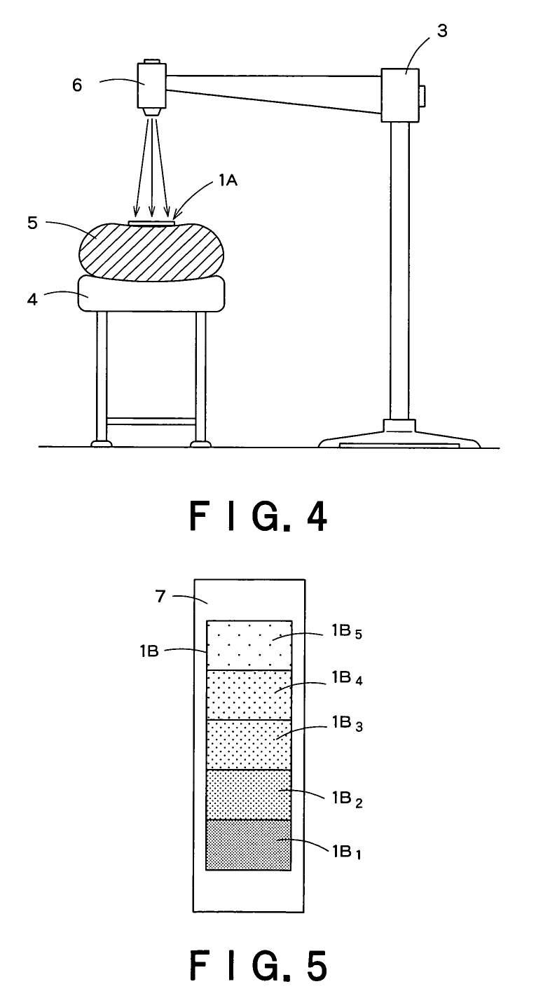

Referring to FIG. 4, the attenuation filter 1A is used by an ultraviolet irradiating apparatus 3 to determine an optimum ultraviolet dose for a patient. The attenuation filter 1A is attached to a test region of the body of a subject (patient) 5 lying on a bed 4. The irradiating head 6 is positioned so that the entire attenuation filter 1A is irradiated uniformly with ultraviolet radiation, and the test region of the body of the patient 5 is exposed to ultraviolet radiation through the attenuation filter 1A. Parts of the skin in the test region are exposed to ultraviolet radiation at ultraviolet doses corresponding to the densities of parts, corresponding to the parts of the skin in the test region, of the attenuation filter 1A.

Consequently, the parts of the skin in the test region are cauterized in tints according to the transmittances of the parts, corresponding to the parts of the skin, of the attenuation filter 1A.

After ultraviolet irradiation has been continued for a predetermined time, ultraviolet irradiation is stopped and the attenuation filter 1A is removed from the skin of the subject 5. Then, the tints of the exposed parts of the test region are visually examined to grasp an optimum ultraviolet dose.

The subject (patient) 5 may be exposed to ultraviolet radiation while the subject 5 is in a standing position in a treatment cabin instead of in a lying position o the bed 4. To avoid exposing parts of the skin around the attenuation filter 1A to ultraviolet radiation, those parts may be covered with a proper mask.

Referring to FIG. 5 showing an optimum ultraviolet dose determining tool in a second embodiment according to the present invention, an attenuation filter 1B is formed longitudinally on a sheet 7. The attenuation filter 1B has parts respectively having different ultraviolet-ray transmittances. The ultraviolet-ray transmittances change stepwise from one end toward the other end of the sheet 7.

As shown in FIG. 5, the successive parts of the attenuation filter 1B have ultraviolet-ray transmittances 1B₁ to 1B₅, respectively. The number of the parts of the attenuation filter 1B is not limited to five and may be any optional number.

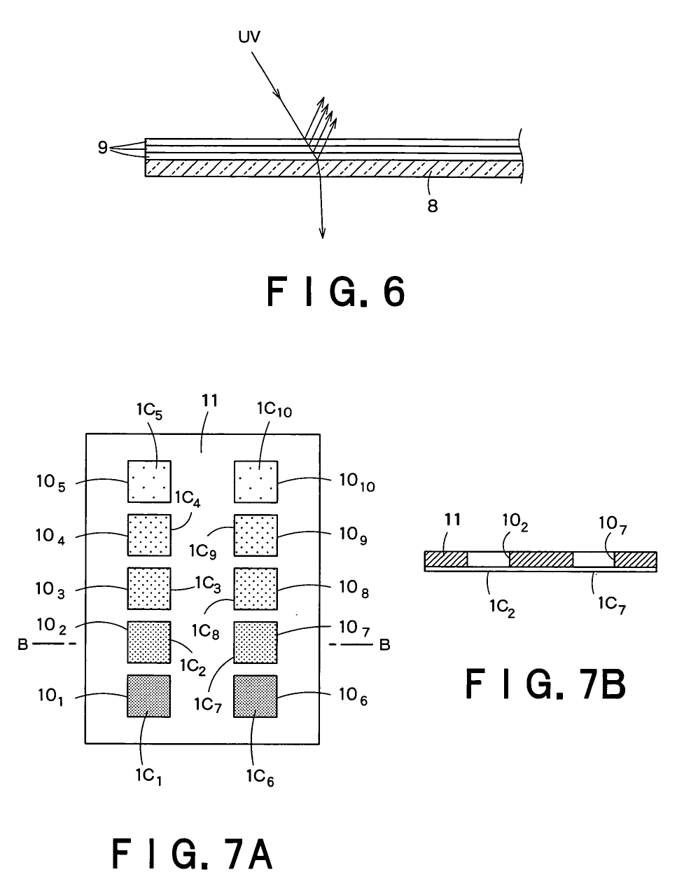

The sheet 7 is attached directly to a test region of the body of a subject, and the test region of the subject's body is exposed to ultraviolet radiation through the attenuation filter 1B. Parts of the skin in the test region are exposed to ultraviolet radiation at ultraviolet doses according to the respective ultraviolet-ray transmittances 1B₁ to 1B₅ of parts, corresponding to the parts of the skin in the test region, of the attenuation filter 1B, and the same parts of the skin are cauterized in tints according to intensities of ultraviolet radiation respectively proportional to the ultraviolet-ray transmittances 1B₁ to 1B₅. Then, the sheet 7 is removed from the skin of the subject. Then, the tints of the exposed parts of the test region are visually examined to grasp an optimum ultraviolet dose. The ultraviolet-ray transmittances of the parts of the attenuation filter 1B may be determined by forming the parts in different densities as explained in connection with FIGS. 1 to 3. An attenuation filter as shown in FIG. 6 may be used. The attenuation filter shown in FIG. 6 is formed by superposing dielectric layers 9 respectively having different reflectances on a base 8 of a nonreflective material, such as quartz glass so that different parts of the attenuation filter have different ultraviolet-ray transmittances.

FIG. 7(A) is a plan view of an optimum ultraviolet dose determining tool in a third embodiment according to the present invention and FIG. 7(B) is a sectional view taken on the line B-B in FIG. 7(A).

The optimum ultraviolet dose determining tool in the third embodiment includes a base plate 11 provided with ten windows 10₁ to 10₁₀ arranged in two rows, and attenuation filters 1C₁ to 1C₁₀ placed in the windows 10₁ to 10₁₀, respectively.

The base plate is formed from a material having affinity to the skin of human bodies, such as a plastic sheet, a cardboard or the like. The windows 10₁ to 10₁₀ are, for example, square openings 10 mm sq.

The number of the windows may be properly determined taking into consideration a required level of measuring accuracy.

The respective ultraviolet-ray transmittances of the attenuation filters 1C₁ to 1C₁₀ decrease stepwise in order of the attenuation filters 1C₁ to 1C₁₀. The attenuation filters 1C₁ to 1C₁₀ are bonded adhesively to the base plate 10.

The transmittances of the attenuation filters 1C₁ to 1C₁₀ may be determined by properly adjusting density as shown in FIG. 3 or by properly adjusting reflectance as shown in FIG. 6.

The base plate 11 is attached directly to a test region of the body of a subject, and the attenuation filters 10₁ to 10₁₀ are irradiated uniformly with ultraviolet radiation to expose the test region of the subject's body to ultraviolet radiation through the attenuation filters 10₁ to 10₁₀. Then, the base plate 11 is removed from the subject's body and the tints of the exposed parts of the test region are visually examined to grasp an optimum ultraviolet dose.

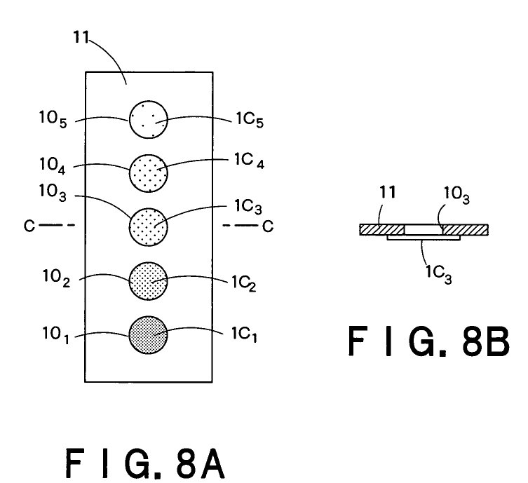

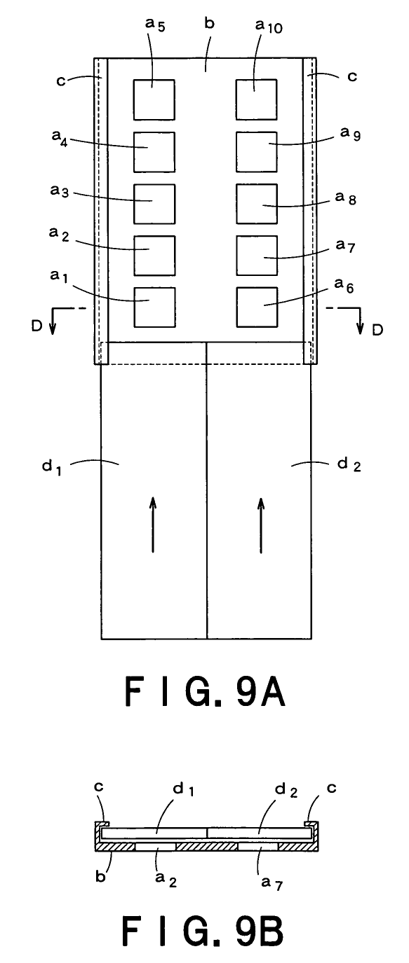

The base plate 11 does not necessarily need to be provided with the ten square windows 10₁ to 10₁₀ the base plate 11 may be provided, for example, with five round windows as shown in FIG. 8.

Both MED and MPD can be measured by using the optimum ultraviolet dose determining tool in the third embodiment.

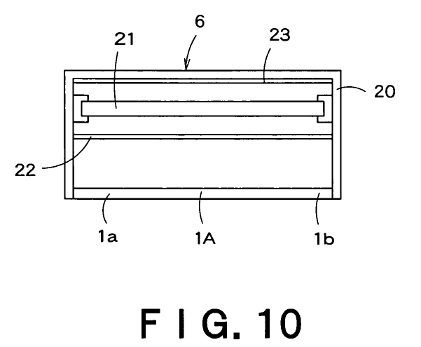

Referring to FIG. 10 showing an optimum ultraviolet dose determining tool in a fourth embodiment according to the present invention for ultraviolet radiotherapy, the optimum ultraviolet dose determining tool includes an irradiation head 6, the attenuation filter 1A and a case 20 holding the irradiation head 6 and the attenuation filter 1A. The irradiation head 6 has a straight ultraviolet lamp 21 and a cylindrical lens 22 for directing ultraviolet rays emitted from the ultraviolet lamp 21 so that the ultraviolet rays may uniformly fall on the attenuation filter 1A. The case 20 has a substantially cylindrical reflecting surface 23 formed on the inner surface of the upper wall thereof. The reflecting surface 23 reflects Ultraviolet rays emitted from the ultraviolet lamp 21 toward the reflecting surface 23 toward the attenuation filter 1A. The ultraviolet lamp 21 is optically sealed in the case 20 such that ultraviolet rays emitted from the ultraviolet lamp 21 travel outside only through the attenuation filter 1A. Either a UV-A lamp or a UV-B lamp is employed as the ultraviolet lamp 21. The ultraviolet lamp 21 of the desired type is attached to sockets attached to the case 20. The attenuation filter 1A may be replaced with the attenuation filter 1B or 1C. When the ultraviolet lamp 21 is able to emit ultraviolet rays uniformly, the cylindrical lens 22 may be omitted.

The optimum ultraviolet dose determining tool provided with the attenuation filter 1A does not need any manual operation, such as a manual operation of the shutter plate, at all and does not need additional members, such as the shutter plates. The irradiation head 6 and the attenuation filter 1A can be easily held in combination in the case 20. Since manual operations, such as the manual operation of the shutter plate, are not necessary, the irradiating head 6 and the attenuation filter 1A can be held in combination in the case 20.

Since the irradiation head 6 and the attenuation filter 1A are combined in an integral unit, the optimum ultraviolet dose determining tool is easy to carry around, needs only being placed on a desired part of the patient, such as the patient's back, for use and can be used in a narrow patient's room.

Since the ultraviolet lamp 21 is optically sealed in the case 20, there is no danger of the examiner being exposed accidentally to ultraviolet radiation.

As mentioned above, the reflection-type attenuation type may be employed instead of the transmission-type attenuation filter to reflect part of light rays emitted from a light source and to irradiate a human body with the rest of the light rays.

1. An optimum ultraviolet dose determining tool for ultraviolet radiotherapy for determining an optimum ultraviolet dose prior to ultraviolet radiotherapy, said optimum ultraviolet dose determining tool comprising an attenuation filter capable of being placed on the skin of a patient and having optical areas respectively having different, known ultraviolet-ray transmittances or reflectances.

2. The optimum ultraviolet dose determining tool according to claim 1, wherein parts of the skin respectively corresponding to the optical areas of the base plate are exposed simultaneously to ultraviolet radiation for the same exposure time.

3. The optimum ultraviolet dose determining tool according to claim 1, wherein the attenuation filter has gradient ultraviolet-ray transmittance or reflectance continuously decreasing from one end toward the other end thereof.

4. The optimum ultraviolet dose determining tool according to claim 1, wherein the attenuation filter has gradient ultraviolet-ray transmittance or reflectance decreasing stepwise from one end toward the other end thereof.

5. The optimum ultraviolet dose determining tool according to claim 1, wherein the attenuation filter is provided with a row of a plurality of windows arranged such that the respective ultraviolet-ray transmittances or reflectances of the windows decrease stepwise in order of arrangement of the windows.

6. The optimum ultraviolet dose determining tool according to any one of claims 1 to 5, wherein the respective ultraviolet-ray transmittances or reflectances of the optical areas are determined by properly adjusting densities of parts, corresponding to the optical areas, of a filter material.

7. The optimum ultraviolet dose determining tool according to any one of claims 1 to 5, wherein the attenuation filter is formed by superposing dielectric layers on a base plate of one of nonreflective materials including quartz glass such that different parts of the dielectric layers have different ultraviolet-ray transmittances or reflectances, respectively.

8. The optimum ultraviolet dose determining tool according to any one of claims 1 to 5, wherein the attenuation filter is held in a case in combination with an ultraviolet lamp.
